(19) United States
(12) Patent Application Publication
(10) Pub. No.: US 2012/0158471 A1
(43) Pub. Date: Jun. 21, 2012

(54) METHOD AND SYSTEM FOR DISPLAYING ADVERTISEMENT ON MOBILE COMMUNICATION DEVICES

(76) Inventors: Jay Kumar Jain, Indore (IN); Vijay Jain, Indore (IN)

(21) Appl. No.: 13/085,693

(22) Filed: Apr. 13, 2011

(30) Foreign Application Priority Data
Dec. 16, 2010 (IN) 3426/MUM/2010

(51) Int. Cl. G06Q 30/00

(52) U.S. Cl. 705/14.4

(57) ABSTRACT

System and method for delivering advertisements to mobile communication devices and presenting the advertisements on the mobile communication devices are disclosed. Also disclosed are techniques by which a network operator may track user involvement with the advertisement and the network operator may offer subsidy for network usage based on the user involvement with the advertisement.

### CROSS-REFERENCE TO RELATED APPLICATION

The present application claims priority under 35 U.S.C. 119(a) to Indian (IN) patent application number 3426/MUM/2010 filed Dec. 16, 2010 entitled Â METHOD AND SYSTEM FOR DISPLAYING ADVERTISEMENT ON MOBILE COMMUNICATION DEVICES, which IN patent application is incorporated herein by reference in its entirety.

### BACKGROUND OF THE INVENTION

1. Field of the Invention

The invention relates generally to mobile communication device and more particularly to methods and systems for displaying advertisement on mobile communication devices.

2. Description of the Prior Art

Mobile communication devices including mobile phones, Personal Digital Assistants (PDA), Tablet Computing Devices, and portable computers, can be configured for voice, data or combined voice and data communication capabilities. Mobile communication devices are commonly used for personal and business communications.

Mobile communication devices use wireless communication networks for data transfer. Usage of wireless communication networks for wireless services for voice, data or voice and data communications by a subscribing user is charged in accordance with a plan (i.e., a contract) having applicable fees.

Communicating via voice based phone call is the most common use of mobile communication devices in wireless communication networks. In the recent years many attempts have been made to reduce the burden on the subscribing user by subsidizing voice based phone calls.

One of the most popular methods for subsidizing phone calls is by placing advertisement before, after or during the phone call. One method of advertisement subsidized wireless communication network usage includes text-based advertising. In such methods the user receives a stipulated number of advertisements for certain subsidy on the wireless communication network usage subscription plan. Text messaging has limited graphic capability and supports only one advertising message or campaign at a time. Text messaging based advertising also requires significant participation or set-up from the user, like opening the message inbox on the mobile communication device, opening individual messages, and following the prompts of the message to access a web/WAP page. This required set-up may not appeal to some mobile communication device users.

In the recent years processors have become smaller and less expensive, along with less expensive and more compact memories. It has become more feasible to increase the processing power on the mobile communication device, which enables applications to be implemented locally on the mobile communication devices. Sun Microsystem's Java technology, which is implemented on mobile communication device as J2ME, offers one possible way of implementing applications on mobile communication devices. In addition, the Binary Runtime Environment for Wireless (BREW) platform, which is described in further detail at http://www.qualcomm.com/brew, offers another way of implementing applications on mobile communication devices. Java and BREW technologies allow applications to be downloaded over the air and stored locally on a mobile communication device.

Using locally implemented applications, advertisers may provide advertising content on mobile communication devices, which may includes a brand name, such as a name of a particular product, service, and company. A growing number of advertisers are also providing advertising content that includes a brand name as well as associated content, such as games, short-form video, animation, or consumer marketing material such as surveys, coupons, or promotions. One drawback of such advertising technique is the difficulty in assessing the impact of the advertisement on the user.

Therefore there exists a need for methods and systems to display advertisement on mobile communication devices such that the advertisements remain appealing to the end consumer and the advertisement impact is measurable by the advertiser. In this regard, the present invention substantially fulfills this need. In this respect, the methods and systems for displaying advertisement on mobile communication devices according to the present invention substantially departs from the conventional concepts and designs of the prior art, and in doing so provides an apparatus primarily developed for the purpose of displaying advertisement on mobile communication devices.

### SUMMARY OF THE INVENTION

In view of the foregoing disadvantages inherent in the known types of mobile communication devices now present in the prior art, the present invention provides an improved methods and systems for displaying advertisement on mobile communication devices, and overcomes the above-mentioned disadvantages and drawbacks of the prior art. As such, the general purpose of the present invention, which will be described subsequently in greater detail, is to provide a new and improved systems for displaying advertisement on mobile communication devices and method which has all the advantages of the prior art mentioned heretofore and many novel features that result in a mobile communication device which is not anticipated, rendered obvious, suggested, or even implied by the prior art, either alone or in any combination thereof.

System and method for delivering an advertisement to mobile communication devices and presenting advertisement on mobile communication devices are disclosed. Also disclosed are techniques by which a network operator can track user involvement with the advertisement. Also disclosed are methods by which a network operator may also offer subsidy for network usage based on the user involvement with the advertisement.

In accordance with one embodiment of the invention a method for displaying advertisement on a mobile communication device is disclosed. The method may be implemented by initiating a wireless communication on a mobile communication device, pausing the wireless communication, presenting an advertisement on the mobile communication device, continuing the wireless communication after the advertisement is displayed, terminating the wireless communication, and presenting a means to respond to the advertisement

In accordance with another embodiment of the invention, advertisement display on mobile communication device may be implemented by storing an advertisement with a set period of display on a mobile communication device; initiating a wireless communication involving the mobile communication device using a pre-defined condition; and presenting the advertisement on the mobile communication device by interrupting the wireless communication for the set period of display; and re-initiating the wireless communication after the set period of display.

In accordance with another embodiment of the invention, a system is provided for displaying advertisement on a mobile communication device. The system may include a server for storing and transmitting advertisement, a mobile communication device with a processor, storage device, a display and a means for downloading advertisement from the server, storing advertisement on the storage device and displaying advertisement on the mobile communication device display.

In accordance with another embodiment of the invention a method for subsidizing a wireless communication on a mobile communication device is provided. The method may be implemented by initiating a wireless communication on a mobile communication device, pausing the wireless communication, presenting an advertisement on the mobile communication device, continuing the wireless communication after the advertisement is displayed, terminating the wireless communication, and sending information about the advertisement to a network operator, wherein the network operator subsidizes the wireless communication after receiving the information about the advertisement.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

The details of one or more implementations are set forth in the accompanying drawings and the description below. Other features will be apparent from the description and drawings, and from the claims.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram of a system for displaying advertisement on a mobile communication device in accordance with one embodiment of the invention.

FIG. 2 is a flow diagram of a process for displaying advertisement on a mobile communication device in accordance with one embodiment of the invention.

FIG. 3 is a flow diagram of a process for managing advertisements for display on a mobile communication device in accordance with one embodiment of the invention.

FIG. 4 is a flow diagram of a process for subsidizing calls on mobile communication device by displaying advertisement in accordance with one embodiment of the invention.

Like reference symbols in the various drawings indicate like elements.

### DETAILED DESCRIPTION OF THE DRAWINGS

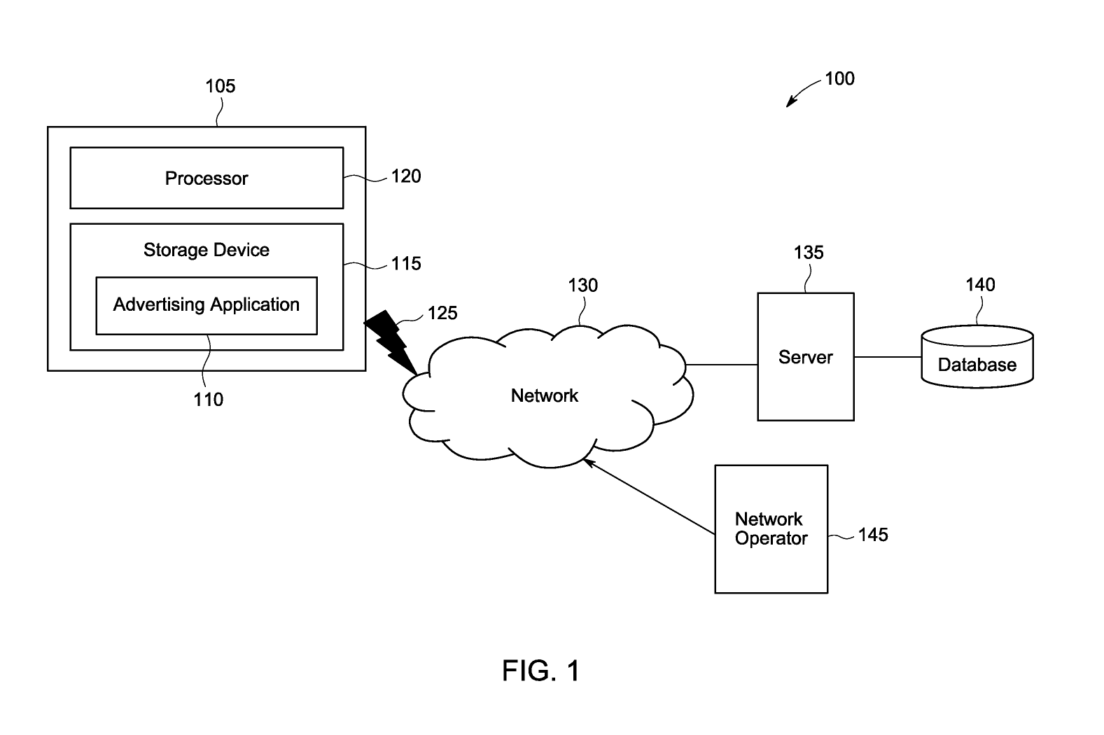

FIG. 1 is a block diagram of a system 100 for displaying an advertisement on a mobile communication device 105 in accordance with one embodiment of the invention. The mobile communication device 105 may include a cellular telephone, a PDA, or another type of handheld wireless communication device. The mobile communication device 105 may be capable of executing one or more software applications, displaying information to a user, and receiving user input. The mobile communication device 105 may include an advertising application 110 that is specially designed for use on mobile communication devices. The advertising application 110 may be stored in a storage device 115 within the mobile communication device 105 and executed on a processor 120. The mobile communication device 105 may operate to conduct wireless communications using a cellular, satellite, or other radio communication link 125 with other devices over a network 130. The network 130 may include, for example, a public land mobile network, a public switched telephone network, a local area network, a wide area network, and/or any other type of telecommunication network.

In accordance with one embodiment, the server 135 may store an advertisement, and receive requests for advertisements from a mobile communication device 105 via advertising application 110 over the communication network 130. In accordance with another embodiment, the server 135 may send advertisements to mobile communication device 105. The server 135 may receive advertisement display information and mobile communication device characteristics from advertising application 110. The server may send advertisement display information and mobile communication device characteristics to a network operator 145. Optionally, the server 135 may store and retrieve advertisements in a database 140.

In accordance with one embodiment the network operator 145 may collect data about network usage from server 135. The network operator 145 may also collect information about advertisement displayed and mobile communication device characteristics. The network operator 145 may offer subsidy to a network user who views the advertisements on the mobile communication device.

In accordance with one embodiment, the advertising application 110 may be stored in the mobile communication device storage device 115 by means of direct downloading via the network from remote servers 135. The mobile communication device manufacturer may preload the advertising application 110 on the mobile communication device 105. The mobile communication device hardware manufacturer may embed the advertising application 110 in the mobile communication device.

The advertising application 110 may download advertisement from server 135 and store them in the storage device 115 via the communication network 130. The advertisement may be downloaded when mobile communication device 105 is not transmitting data. The advertisement may be plain text based, static image, videos, audios and/or banner images.

The advertising application 110 may display an advertisement on the mobile communication device when a call is initiated using certain pre-defined conditions. The advertisement may be displayed for a set period of display. The set period of display may correspond to the total time the advertisement is displayed. The set period of display may correspond to the total time a video plays. The advertiser may stipulate the set period of display. The set period of display may be adjustable by the user of a mobile communication device.

To facilitate portability and/or compatibility among different devices and type of devices, the advertising application 110 may be implemented, for example, on a Java™ platform, a J2ME platform, a BREW platform, a Symbian operating system, Linux, a Pocket PC operating system, a Palm operating system, a Microsoft operating system, or any other mobile software platform. The advertising application 110 can include software code defining the structure and other operations and features of the advertising application 110 or the structure, other operations, and/or other features of the advertising application 110 can be stored in one or more separate files on the mobile communication device 105.

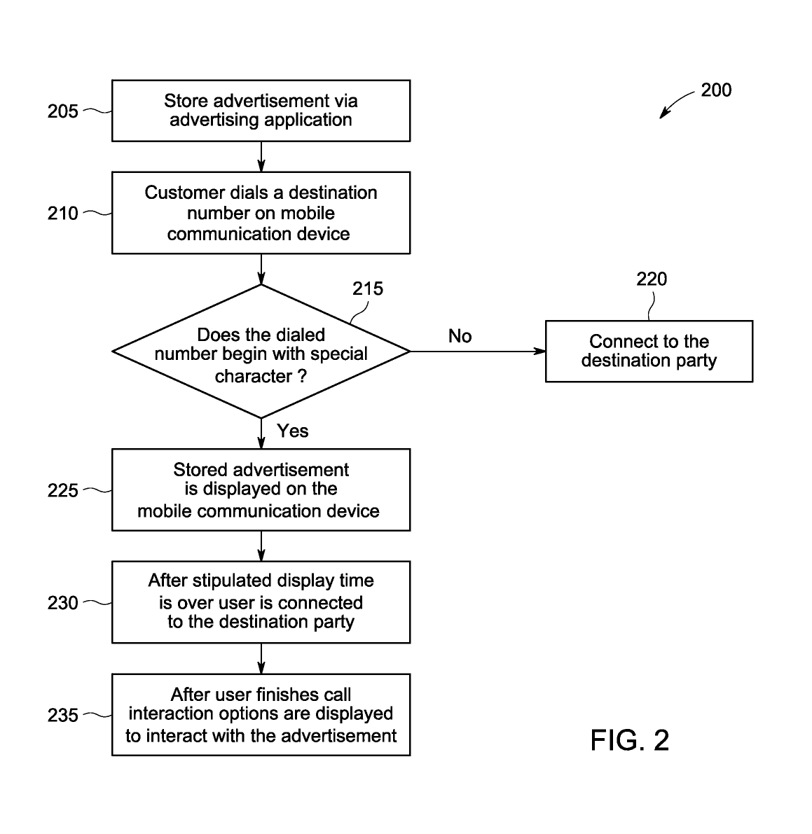

FIG. 2 is a flow diagram of a process 200 for displaying advertisement on a mobile communication device 105 in accordance with one embodiment of the invention. In accordance with one embodiment, advertising application 110 (refer FIG. 1) downloads advertisement to the mobile communication device 105 (step 205). The advertisement may be stored in an erasable memory such that the advertisement may be overwritten with other data. For example, after a specified time period, the advertisement may be replaced with a new advertisement. In some implementations, more than one advertisement may be stored so that a different advertisement may be presented to a user of the mobile communication device 105.

A wireless communication may be initiated on the mobile communication device by dialing (step 210). The wireless communication may be a voice call, video call, IP call, a data call or a combination of them. The data call may be to open a web browser, open any Universal Resource Locator (URL) of a web or a Wireless Application Protocol (WAP) portal, send text message or multimedia message or Network Messages, request for Unstructured Supplementary Service Data (USSD) alerts, download wallpapers or animations or themes or ringtones or Full track music songs, download videos, open video calls or Interactive Voice Response (IVR) or Video conferencing, download games or applications or software, download any other content or services whether in text, image, sound, video or any other visible formats, opening a location based service or opening location maps and travel routes, opening a social network website, or a social network application. The wireless communication may be initiated via dialing a phone number. The wireless communication may be initiated by dialing an alphanumeric code.

Advertising application 110 checks if the dialed call satisfies a predefined condition (step 215). The predefined condition may be presence of certain special characters or strings in the dialed call. The dialed call number or alphanumeric code may contain special characters like hash (#) or asterisk (*).

If the predefined condition is satisfied by the dialed call, a stored advertisement is presented (step 225). If the predefined condition is not satisfied by the dialed call, the call is connected to the destination (step 220). The presentation of stored advertisement may occur while the dialed call is being initiated in the background or the call may be interrupted to present the stored advertisement.

The stored advertisement is presented for a set period of time before the dialed call is connected to the destination (step 230). The set period of display may correspond to the total time the advertisement is displayed. The set period of display may correspond to the total time a video plays. The advertiser may stipulate the set period of display. The set period of display may be adjustable by the user of a mobile communication device.

After the set period of display of the advertisement the dialed call is connected to the destination. After the dialed call is terminated, means to respond to the advertisement may be presented (step 235). The means may be a merchant portal for purchasing the advertised product. The means may be an online product purchase portal. The means may be a quiz page. The means may be a product discount coupon. The means may be a feedback regarding the advertisement, wherein the feedback may be a poll or a quiz. The means to respond may be a message to choose a subsidy plan for viewing the advertisement. The means may be to download digital gifts like wallpapers or music. The means to respond may be a message to choose a subsidy plan.

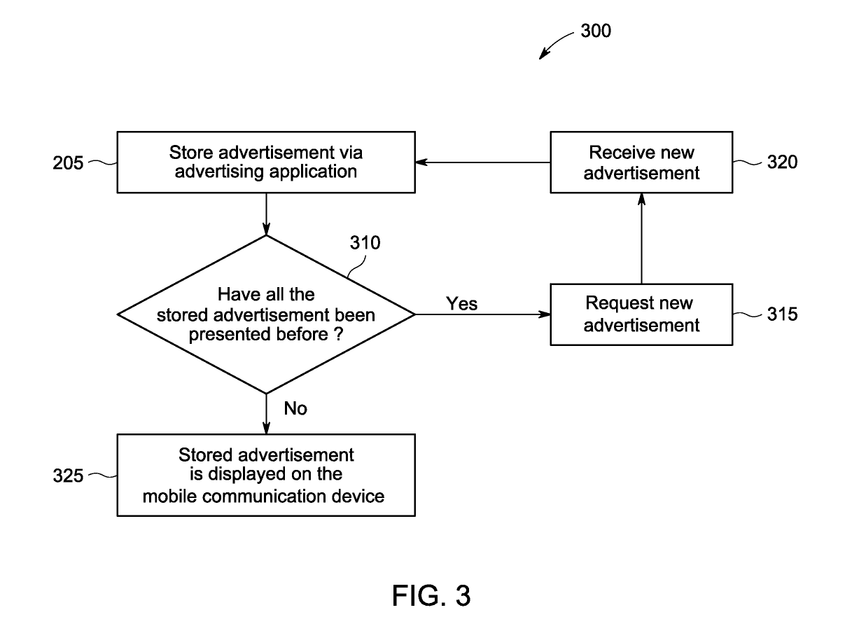

FIG. 3 is a flow diagram of a process 300 for managing advertisements for display on a mobile communication device 105 in accordance with one embodiment of the invention. Initially, advertising application 110 of the FIG. 1 downloads advertisement to the mobile communication device 105 (step 205 of FIG. 2). Before the advertisement is presented on the mobile communication device to a user, a check is done to ensure if the advertisement has been presented previously (step 310). The advertisements stored on the device may be used only for a certain period of time or number or displays. The period of time may be based on a set renewal or expiration date. The period of time for renewal may be stipulated by an advertiser or by the user of the mobile communication device.

If all the advertisements stored on the mobile communication device 105 have been presented previously via advertising application 110 they may be refreshed or replaced (step 315). The request for renewal or notice of expiration may be sent to a server. A new advertisement may be received in response from the server for a request for new advertisements (step 320). The new advertisements may be stored on the mobile communication device 105 via advertising application 110 in storage device 115.

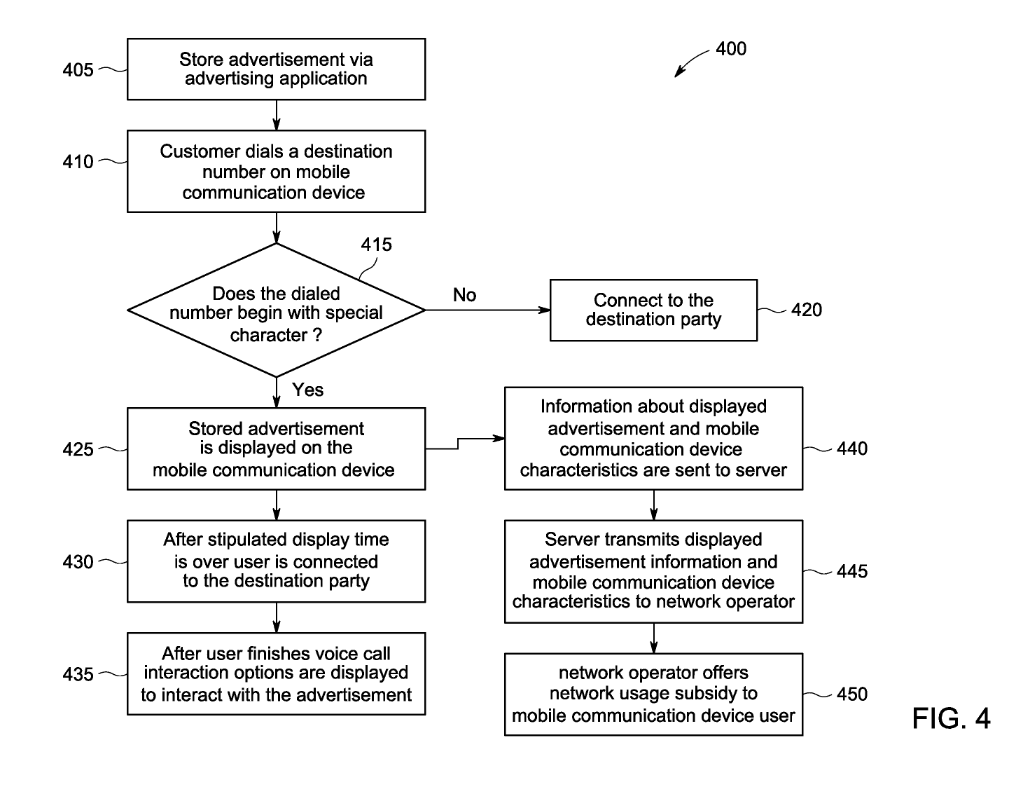

FIG. 4 is a flow diagram of a process 400 for subsidizing calls on mobile communication device 105 by displaying advertisement in accordance with one embodiment of the invention. Initially, advertising application 110 of the FIG. 1 downloads an advertisement to the mobile communication device 105 (step 405). The advertisement may be stored in an erasable memory such that the advertisement may be overwritten with other data. For example, after a specified time period, the advertisement may be replaced with a new advertisement. In some implementations, more than one advertisement may be stored so that a rotation of several different advertisements can be presented to a user of the mobile communication device.

A wireless data communication is initiated on the mobile communication device by dialing for making a call (step 410). The dialed call may be a voice call, video call, IP call a data call or a combination of them. The wireless communication may be initiated via dialing a phone number. The wireless communication may be initiated by dialing an alphanumeric code.

Advertising application 110 checks if the dialed call satisfies a predefined condition (step 415). The predefined condition may be presence of certain special characters or strings in the dialed call. The dialed call number or alphanumeric code may contain special characters like hash (#) or asterisk (*).

If the predefined condition is satisfied by the dialed call a stored advertisement is presented (step 425). If the predefined condition is not satisfied the call is connected to the destination (step 420). In one embodiment, the presentation of stored advertisement may occur while the dialed call is being initiated in the background. In another embodiment, the call may be interrupted to present the stored advertisement.

The stored advertisement is presented for a set period of time before the dialed call is connected to the destination (step 430). The set period of display may correspond to the total time the advertisement is displayed. The set period of display may correspond to the total time a video plays. The advertiser may stipulate the set period of display. The set period of display may be adjustable by the user of a mobile communication device.

Information about advertisement display and mobile communication device characteristics are sent to a server 135 (step 440). The information about advertisement display may include the advertisement being displayed, advertiser of the advertisement, number of times the advertisement has been viewed, time of the day the advertisement is displayed and duration for which the advertisement is presented etc. The mobile communication device characteristics may include the device type, the device location, device model, Mobile Identification Number (MIN), Mobile Directory Number (MDN), device software platform, and/or network operator name and characteristics.

The server sends information about advertisement display and mobile communication device characteristics to a network operator 145. The network operator 145 may collect the data to request compensation from the advertisers. The network operator 145 may collect the data to offer more targeted advertisements to the user of the mobile communication device. The network operator 145 may collect the data for optimizing advertisement characteristics. The advertisement characteristics may include type of the advertisement, product category of the advertisement, advertiser of the advertisement, number of times the advertisement has been viewed, time of the day the advertisement is displayed and/or duration for which the advertisement is presented.

In one embodiment, the network operator 145 may offer network usage subsidy based on the information about advertisement display and mobile communication device characteristics (step 450). The network operator 145 may subsidize the call placed immediately after the advertisement by tracking the success of the call. The network usage subsidy may include free calls, free minutes, value added services, browsing bandwidth, and discount coupons.

The systems and all of the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, operations of the logic flows depicted in FIGS. 2, 3 and 4 can be performed in a different order than that shown and/or can be performed iteratively.

The embodiments described herein are examples of compositions, structures, systems and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed as being new and desired to be protected by Letters Patent of the United States is as follows:

1. A method for displaying advertisement on a mobile communication device, the method comprising the steps of:
initiating a wireless communication on a mobile communication device;
pausing the wireless communication;
presenting an advertisement on the mobile communication device;
continuing the wireless communication after the advertisement is displayed;
terminating the wireless communication; and
presenting a means to respond to the advertisement.

2. The method of claim 1, wherein the wireless communication is initiated by dialing a number on the mobile communication device.

3. The method of claim 1, wherein the dialed number further comprising at least one special characters

4. The method of claim 3, wherein the special character is at least one of hash (#), and asterisk (*).

5. The method of claim 1, wherein the wireless communication is a voice call.

6. The method of claim 1, wherein the wireless communication is a video call.

7. The method of claim 1, wherein the wireless communication is an Internet Protocol based communication.

8. The method of claim 1, wherein the wireless communication is a data call.

9. The method of claim 1, wherein the advertisement is a text message.

10. The method of claim 1, wherein the advertisement is a video.

11. A system for displaying advertisement on a mobile communication device, the system comprising:
a server for storing and transmitting an advertisement;
a mobile communication device comprising;
a processor;
a storage device;
a display; and
a means for downloading the advertisement from the server, storing the advertisement on the storage device, and displaying the advertisement on the display.

12. The system of claim 13, wherein the means further comprising a client application operable to download the advertisement from the server, store the advertisement on the storage device, and display the advertisement on the display.

13. The system of claim 13, wherein the advertisement is a text message.

14. The system of claim 13, wherein the advertisement is a video.

15. A method for subsidizing a wireless communication on a mobile communication device, the method comprising the steps of:
initiating a wireless communication on a mobile communication device;
pausing the wireless communication;
presenting an advertisement on the mobile communication device;
continuing the wireless communication after the advertisement is displayed;
terminating the wireless communication; and
sending information about the advertisement to a network operator, wherein the network operator subsidizes the wireless communication after receiving the information about the advertisement.

16. The method of claim 15, wherein the wireless communication is initiated by dialing a number on the mobile communication device.

17. The method of claim 15, wherein the dialed number further comprising at least one special characters.

18. The method of claim 17, wherein the special character is at least one of hash (#), and asterisk (*).

19. The method of claim 15, wherein the wireless communication is a voice call.

20. The method of claim 15, wherein the wireless communication is a data call.
